(19) United States
(12) Patent Application Publication
(10) Pub. No.: US 2019/0347892 A1
(43) Pub. Date: Nov. 14, 2019

(54) Apparatus And Method Of Playing A Game Of Chance

(71) Applicant: Club Gaming Pty Ltd, Southbank (AU)

(72) Inventors: Linh Kohl, Southbank (AU); Paula Jean Stewart, Roxburgh Park (AU)

(21) Appl. No.: 16/307,900

(22) PCT Filed: Jun. 2, 2017
(86) PCT No.: PCT/AU2017/050539

§ 371 Date: Dec. 6, 2018

(30) Foreign Application Priority Data
Jun. 6, 2016 (AU) 2016902193

(51) Int. Cl. G07F 17/32

(52) U.S. Cl. CPC G07F 17/322; G07F 17/3244; G07F 17/3276; G07F 17/3293

(57) ABSTRACT

Embodiments generally relate to a gaming table for playing a game of chance, the table comprising a table surface; at least one betting area designated on the table surface; and two or more segments in each betting area, each segment corresponding to a different property of a hand of cards and having a predetermined payout amount. The betting area corresponds to at least one property of at least one of the cards; and the segments are arranged on the gaming table so that the segment having the highest payout amount is positioned closest to a dealer's area of the table.

### TECHNICAL FIELD

The present disclosure relates to an improved gaming system and an improved method, and apparatus for gaming

### BACKGROUND

Players often become bored and disinterested when playing the same card game for a long period of time. However, players may not wish to devote time and energy into learning complicated rules for new card games, and may become disinterested if they find it difficult to understand the rules of a game.

It is desired to address or ameliorate one or more shortcomings or disadvantages associated with prior methods and apparatus for gaming, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a gaming table for playing a game of chance, the table comprising:
a table surface;
at least one betting area designated on the table surface; and
two or more segments in each betting area, each segment corresponding to a different property of a hand of cards and having a predetermined payout amount;
wherein the betting area corresponds to at least one property of at least one of the cards; and
wherein the segments are arranged on the gaming table so that the segment having the highest payout amount is positioned closest to a dealer's area of the table.

Some embodiments relate to a method of playing a game of chance using at least one deck of cards and the gaming table according to some other embodiments, the method comprising the steps of:
receiving at least one token in at least one betting area;
a dealer dealing at least one card to form a house hand; and
determining a winning outcome for the player based on a relationship between at least one property of the house hand, and the player selected betting area.

Some embodiments relate to a method of playing a game of chance using at least one deck of cards and a gaming table, the gaming table comprising a table surface, at least one betting area designated on the table surface, the betting area corresponding to at least one property of a hand of cards, the method comprising the steps of:
receiving at least one token in at least one betting area;
a dealer dealing at least one card to form a house hand; and
determining a winning outcome for the player based on a relationship between at least one property of the house hand, and the player selected betting area.

According to some embodiments, the at least one deck of cards is a standard deck of cards.

According to some embodiments, the at least one property of a hand of cards corresponds to the characteristics of a standard poker hand.

Some embodiments further comprise determining a winning amount based on a relationship between at least one property of the house hand, and the player selected betting area.

Some embodiments relate to a gaming table for playing a game of chance according to the method of some other embodiments, the table comprising:
a table surface; and
at least one betting area designated on the table surface;
wherein the betting area corresponds to at least one property of at least one of the cards.

According to some embodiments, the betting area includes two or more segments, each corresponding to a different property of a hand of cards.

Some embodiments relate to a method of playing a game of chance using a gaming table, the gaming table comprising a table surface, an electronic betting controller, and at least one betting area designated on the table surface, the betting area corresponding to at least one property of a hand of cards, the method comprising the steps of:
receiving from at least one player an electronic selection of a virtual betting area using an input device in communication with the electronic betting controller;
a dealer dealing at least one card to form a house hand; and
the electronic betting controller determining a winning outcome for the player based on a relationship between at least one property of the house hand, and the player selected betting area.

According to some embodiments, the at least one deck of cards is a standard deck of cards.

According to some embodiments, the at least one property of a hand of cards corresponds to the characteristics of a standard poker hand.

Some embodiments further comprise the electronic betting controller determining a winning amount based on a relationship between at least one property of the house hand, and the player selected betting area.

According to some embodiments, the at least one card is dealt virtually.

Some embodiments relate to a gaming table for playing a game of chance according to the method of some other embodiments, the table comprising:
a table surface; and
an electronic betting controller comprising:
   a processor;
   a memory storing code executable by the processor; and
   at least one input device;
wherein the input device is configured to accept input corresponding to at least one property of at least one card of a deck of cards.

Some embodiments further comprise an output device configured to display at least one received bet.

According to some embodiments, each segment has a predetermined payout amount. According to some embodiments, the segments are arranged on the gaming table so that the segment having the highest payout amount is positioned closest to a dealer's area of the table. In some embodiments, the dealer's area comprises a card dealing area.

According to some embodiments, at least one segment corresponds to the drawn hand of cards being at least one of a set of predetermined standard poker hands. In some embodiments, the set of predetermined standard poker hands includes at least one of a royal flush, straight flush, five of a kind, four of a kind, full house, flush or straight.

According to some embodiments, at least one segment corresponds to the drawn hand of cards being of a predetermined card suit. In some embodiments, the predetermined card suit is at least one of hearts, spades, diamonds or clubs.

According to some embodiments, the table comprises two or more betting areas.

### BRIEF DESCRIPTION OF DRAWINGS

Embodiments are described below in further detail and by way of example, with reference to the accompanying drawing, in which:

FIG. 1A shows a perspective view of a gaming table according to some embodiments;

FIG. 1B shows a top view of a gaming table according to some embodiments;

FIG. 2 shows a flow diagram illustrating a method of gaming according to some embodiments;

FIG. 3 shows a betting area arrangement according to some embodiments;

FIG. 4 shows an alternative betting area arrangement according to some embodiments;

FIG. 5 shows a block diagram of an electronic gaming apparatus according to some embodiments;

FIG. 6 shows a flow diagram illustrating a method of gaming using the electronic gaming apparatus according to some embodiments;

FIG. 7 shows a top view of a betting area arrangement according to some embodiments; and

FIG. 8 shows a gaming table according to some embodiments.

### DESCRIPTION OF EMBODIMENTS

Described embodiments generally relate to an improved gaming system and an improved method and apparatus for gaming

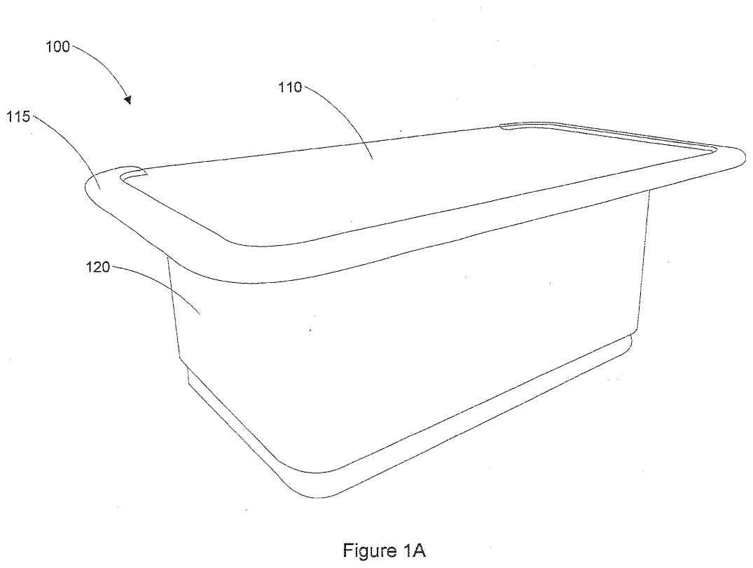

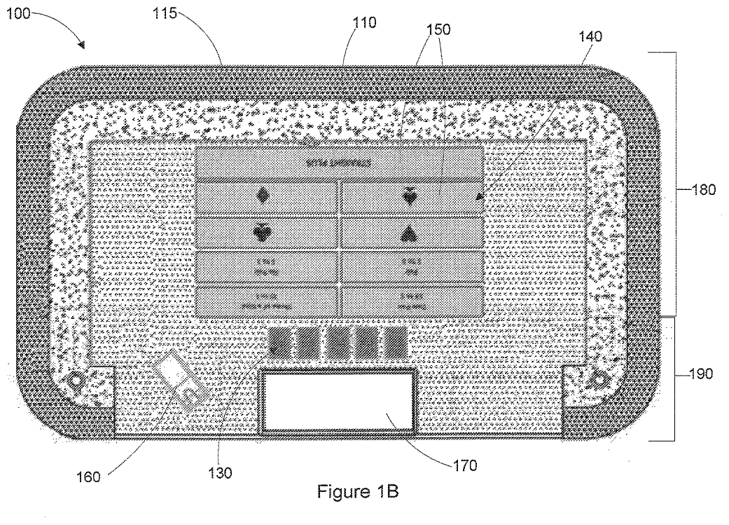

FIG. 1 shows a gaming apparatus 100, according to some embodiments, which may be a table, bench, or other apparatus. According to some embodiments, gaming apparatus 100 includes a gaming surface 110, and a support structure 120 to support gaming surface 110. Gaming surface 110 may be at least partially surrounded by a raised perimeter 115. Gaming surface 110 is described in further detail below with reference to FIG. 1B. According to some embodiments, support structure 120 may be one or more legs, struts, columns, trusses, walls, or other support structures.

According to some embodiments, gaming apparatus 100 may be used to play a game with a plurality of playing cards 310 (shown in FIG. 1B). According to some embodiments, the plurality of playing cards 310 may include one or more cards from a standard deck of cards. According to some embodiments, the plurality of playing cards 310 may include one or more standard decks of cars. According to some embodiments, 2, 3, 4, 5, 6, 7, 8, 9, 10 or more decks of standard cards may be used. A standard deck of cards may be a 52 card deck including four suits, which may include hearts, clubs, spades and diamonds, in some embodiments. Each suit may include 13 ranks of cards, which may include number cards being numbered between 2 and 10, as well as face cards, which may include a Jack, a Queen and a King card, and an ace card. Some standard decks may include one or more Joker cards.

According to some embodiments, one or more non-standard cards or decks of cards may be used. At least two cards in the plurality of cards 310 may be distinguishable from one another based on at least one property, such as colour or design, visible on at least one face of the card. The at least one property may correspond to at least one of betting segments 150. According to some embodiments, each card may comprise a front side, having distinguishable information displayed, and a back side, being indistinguishable from the back side of any other card in the plurality of cards. The front side of each card may include one or more of a suit and a value, according to some embodiments.

According to some embodiments, gaming apparatus 100 may be used to play a game with a plurality of betting tokens. The betting tokens may be standard poker chips according to some embodiments. According to some alternative embodiments, tokens may be chips, markers, currency, or any other form of token that can be used to represent currency may be used. According to some embodiments, different forms of tokens may correspond to different monetary values. For example, different coloured tokens may denote different monetary values. In some embodiments, the shape and/or size of each token may correspond to a monetary value.

FIG. 1B shows a top view of gaming apparatus 100, showing gaming surface 110 and raised perimeter 115. Gaming surface 110 may include a players' area 180 and a dealer's area 190. Player's area 180 may include a betting area 140, and dealer's area 190 may include a card dealing area 130. Gaming surface 110 may be a felt-covered gaming surface in some embodiments. Raised perimeter 115 may be covered in leather or fabric in some embodiments, or may be formed as a wooden, plastic, or metal bumper in some embodiments.

Gaming surface 110 may be generally rectangular in shape, and may have curved corners in some embodiments. In some embodiments, gaming surface 110 may be semi-circular in shape. According to some embodiments, gaming surface 110 may be another shape, such as generally square, oval, or circular. According to some embodiments, players' area 180 may be situated along one long edge of the rectangular surface, and a dealer's area 190 may be situated on the opposing long edge of the rectangular surface. Betting area 140 may be positioned centrally along the players' area 180, and card dealing area may be positioned centrally along the dealer's area 190. Gaming surface 110 may be sized so that a dealer standing proximate dealer's area 190 may be able to reach the opposite side of gaming surface using a standard chip rake.

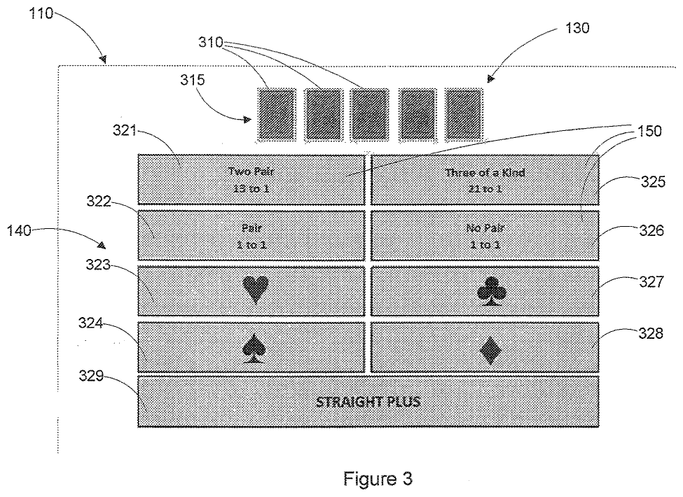

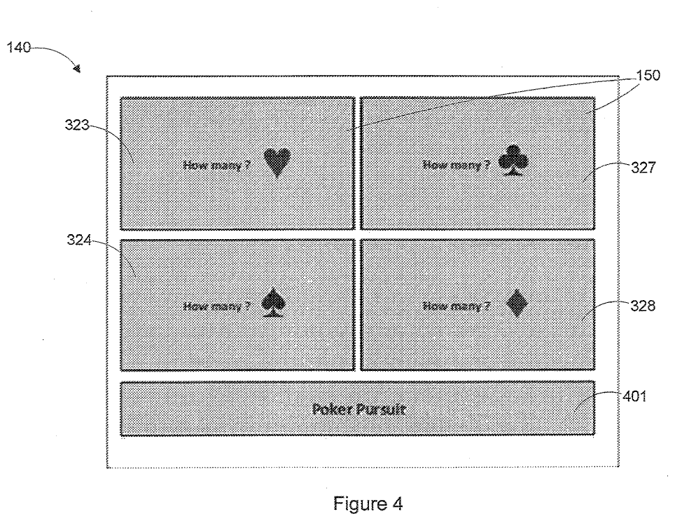

Betting area 140 may be divided into two or more different betting segments 150 demarcated by lines or other graphic representations printed, painted, engraved, or otherwise fixed onto the gaming surface 110 in some embodiments, as described in further detail below with reference to FIGS. 3 and 4. Each betting segment 150 may correspond with at least one game outcome or at least one property of at least one playing card, as described below. Furthermore, each betting segment 150 may be designated a value or probability, corresponding to the probability that the game outcome corresponding to the betting segment 150 is likely to occur. A textual or pictorial representation of the at least one game outcome or property that is associated with each betting segment 150 may be printed, painted, engraved, or otherwise marked onto gaming surface 110, within or in proximity to the lines or other graphic representations demarcating the betting segment 150. Any textual or pictorial representations may be oriented to be readable from the players' area 180. According to some embodiments, card dealing area 130 may be at one side or end of apparatus 100, while betting area 140 may be on the opposite side of apparatus 100. Apparatus 100 may be configured to allow a dealer or game official to easily access card dealing area 130, while allowing one or more players to easily access betting area 140.

Card dealing area 130 may include at least one shape printed, painted, engraved, or otherwise marked onto gaming surface 110, to designate where a dealer should place any dealt cards. In some embodiments, card dealing area 130 may include a single marked shape, which may be a rectangle in some embodiments, into which each dealt card is placed. According to some embodiments, card dealing area 130 may include a marked shape for each card to be dealt. The marked shapes may be sized and shaped to match the size and shape of the playing cards 310. According to some embodiments, card dealing area 130 may include pictorial depictions of the back side of the playing cards 310. Any textual or pictorial representations in card dealing area 130 may be oriented to be readable from the dealer's area 190.

During game play, a dealer or game official may stand proximate the dealer's area 190, while players may stand around the edges of gaming apparatus 100 bounded by raised perimeter 115, proximate players' area 180. Gaming surface 110 may further include a card shoe 160 for holding cards 310 to be dealt, and a float tray 170 for holding betting tokens. According to some embodiments, card shoe 160 may be any mechanical or electronic card shoe configured to assist in dealing one or more cards from a plurality of cards, and may be positioned to the left hand side of card dealing area 130 from the point of view of a dealer standing proximate dealer's area 190. Float tray 170 may be recessed into gaming surface 110, or positioned to stand up on gaming surface 110, and may include one or more divided recesses shaped and sized to each hold one or more betting tokens. Float tray 170 may be positioned closer to the edge of gaming surface 110 than card dealing area 130, such that card dealing area 130 is positioned between float tray 170 and betting area 140.

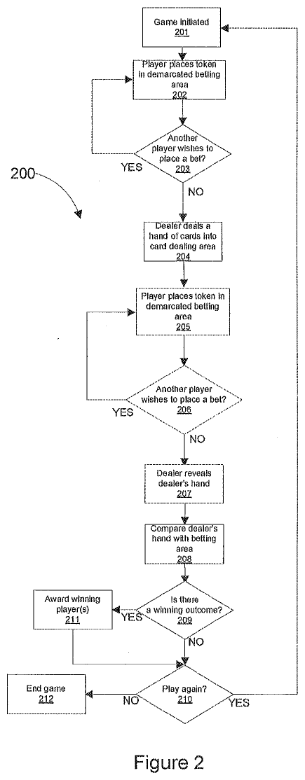

FIG. 2 shows a flowchart 200 showing a method of playing a game using gaming apparatus 100 and plurality of playing cards 310. The method starts at step 201 when a game is initiated, and a dealer or game official asks players to place their bets. At step 202, a player places a bet by placing one or more betting tokens on or in proximity to a betting segment 150. A bet may be considered to be placed if at least part of a betting token is within a betting segment 150. According to some embodiments, where a betting token is within more than one betting segment 150, this may be considered to be two bets, each being of half of the value of the betting token. For example, if a betting token with a designated value of S10 is placed so that it is within two betting segments 150, this may be considered to be a bet of S5 for each of the two betting segments that the token is partially within. According to some embodiments, if it is unclear whether a betting token is within a betting segment 150, the dealer may clarify with the player that placed that betting token what the player had intended to bet on.

According to some embodiments, a player may elect to only place one token on the betting area 140, or may place tokens in only one betting segment 150. In some embodiments, each player may place as many tokens in as many segments 150 as they desire. The betting segment the player elects to place a token on may correspond to a property of a card that the player believes will be drawn by the dealer or game official. At step 203, if another player wants to place a bet, the method moves back to step 202. Alternatively, the method moves through to step 204.

At step 204, the dealer or game official may announce that no more bets will be taken, and then deal one or more cards from the plurality of cards 310 and place them on card dealing area 130 to form a dealer's hand or house hand 315 (as shown in FIG. 3). According to some embodiments, the cards may be dealt using card shoe 160, or other device for holding or dealing cards. According to some embodiments, the dealer may deal a predetermined number of cards, which may be 1, 2, 3, 4, 5, 6, 7, 8, 9, 10 or more cards. According to some embodiments, the dealer may keep dealing cards until a predetermined event occurs, such as a predetermined card being drawn, for example. According to some embodiments, the dealer may draw the cards face up to show the front side of the card. According to some alternative embodiments, the cards may be drawn with the back side facing up, and later flipped to reveal the front side.

If the cards are drawn with the back side up, players may be optionally be allowed to place bets after the cards have been drawn, at step 205. At step 205, a player may place a bet by placing one or more betting tokens on or in proximity to a betting segment 150. A bet may be considered to be placed if at least part of a betting token is within a betting segment 150, as described above with reference to step 202. At step 206, if another player wants to place a bet, the method moves back to step 205. Alternatively, the method moves through to step 207.

At step 207, if the cards have been drawn with the back side facing up, the dealer may optionally flip the cards to display their front side.

Once the cards have been drawn and their values, suits, or other distinguishing features have been revealed, the method moves to step 208, at which time game outcomes are evaluated. The evaluation is done by comparing the characteristics of the cards drawn to make up the dealer's hand with the characteristics corresponding to betting segments 150. If the characteristics of one or more drawn cards 310 of the dealer's hand 315 match a betting segment 150, and a player has placed a betting token in that betting segment 150, a winning outcome is considered to have occurred in favour of that player. As the dealer evaluates the game outcomes, the dealer may use a chip rake to remove any betting tokens from betting area 140 that do not correspond to a winning outcome, and to place these tokens into float tray 170. At step 209, if a winning outcome is determined, the method moves to step 211. Alternatively, the method moves to step 210.

At step 211, any winning players are awarded. The award may be in the form of betting tokens, wherein the monetary value of the betting tokens awarded is relative to the monetary value of the betting token used to place the bet, and/or the value corresponding to the betting segment 150. These tokens may be taken from float tray 170, and passed on to the winning player or players by the dealer.

At step 210, the one or more players may be given the opportunity to play again. If at least one player elects to play again, the method may return to step 201. Alternatively, the game may end at step 212.

FIG. 3 shows a playing surface 110 according to some embodiments, having a card dealing area 130 and a betting area 140 made up of nine betting segments 150. In the illustrated embodiment, five cards 310 have been dealt to card dealing area 130 to make up a dealer's hand 315. Betting segments 150 may include segments that relate to properties of the cards 310 making up the dealer's hand 315. According to some embodiments, the betting segments may correspond to typical hands used for the game of poker. For example, where one or more standard decks of cards is being used, betting segments 150 may correspond to one or more of:
a straight flush, being five cards in sequence, all of the same suit;
four of a kind, being four cards of one rank and any other unmatched card;
a full house, being three matching cards of one rank and two matching cards of another rank;
a flush, being five cards of the same suit, but not in sequence;
a straight, being five cards of sequential rank in at least two different suits;
three of a kind, being three cards of the same rank, plus two cards which are not of this rank nor the same as each other;
two pair, being two cards of the same rank, plus two cards of another rank that match each other but not the first pair, plus any card not of either rank; and
one pair, being two cards of one rank, plus three cards which are not of this rank nor the same as each other.

In the illustrated embodiment, betting segments 150 include a two pair betting segment 321, a pair betting segment 322, a hearts betting segment 323, a spades betting segment 324, a three of a kind betting segment 325, a no pair betting segment 326, a clubs betting segment 327, a diamonds betting segment 328, and a straight plus betting segment 329. Segments 321, 322, 325 and 326 show the odds of the game outcome corresponding to the segment occurring in any given game. The odds may also correspond to a predetermined payout amount for the segment. For example, segment 321 shows that an outcome of two pairs will result in winnings of 13 to 1 based on the player's bet amount. Segment 322 shows that the odds for getting a pair are 1 to 1, segment 325 shows that the odds for getting three of a kind are 21 to 1, and segment 326 shows that the odds for getting no pairs are 1 to 1.

Betting on one of the suit segments 323, 324, 327 or 328 may result in a winning outcome if two or more of the cards dealt to dealer's hand 315 are of the suit bet on.

According to some embodiments, the amount won may depend on the number of cards dealt of the selected suit. For example, a result of 5 cards with the selected suit may payout with odds of 50 to 1, a result of 4 cards with the selected suit may payout with odds of 4 to 1, a result of 3 cards with the selected suit may payout with odds of 2 to 1, and a result of 2 cards with the selected suit may payout with odds of 1 to 1.

Betting on straight plus segment 329 may result in a winning outcome if the dealer's hand is a royal flush, straight flush, five of a kind, four of a kind, full house, flush, straight, or other predetermined card combination. According to some embodiments, a royal flush may payout with odds of 500 to 1, a straight flush may payout with odds of 400 to 1, a five of a kind may payout with odds of 300 to 1, a four of a kind may payout with odds of 100 to 1, a full house may payout with odds of 100 to 1, a flush may payout with odds of 50 to 1, and a straight may payout with odds of 25 to 1. Table 1 below shows an example payout scheme for the payout area 140 illustrated in FIG. 3.

TABLE 1
Single Outcome Wagers

| Wager | Payout | Edge |
|---|---|---|
| No Pair | 1 | 15.09% |
| Pair | 1 | 8.52% |
| Two Pair | 13 | 7.95% |
| Three of a Kind | 21 | 7.76% |

| | | |
|---|---|---|
| Outcome | Payout | Edge |

Straight or Better Wager

| | | |
|---|---|---|
| Royal Flush | 500 | 10.11% |
| Straight Flush | 400 | |
| Five of a Kind | 300 | |
| Four of a Kind | 150 | |
| Full House | 100 | |
| Flush | 50 | |
| Straight | 25 | |
| Other Hands | −1 | |

Specific Suit Wager

| | | |
|---|---|---|
| 0 cards | −1 | 9.34% |
| 1 card | −1 | |
| 2 cards | 1 | |
| 3 cards | 2 | |
| 4 cards | 4 | |
| 5 cards | 50 | |

FIG. 4 shows an alternative betting area 140 made up of five betting segments 150. Betting segments 150 include hearts betting segment 323, spades betting segment 324, clubs betting segment 327, and diamonds betting segment 328. Betting segments 150 also include a poker pursuit segment 401. Poker pursuit segment 401 may be used to bet on a number of different game outcomes, including getting two pair, a pair, three of a kind, no pairs, a royal flush, straight flush, five of a kind, four of a kind, full house, flush, straight, or other predetermined card combination. The odds for each of these results may be similar to those described above with reference to FIG. 3.

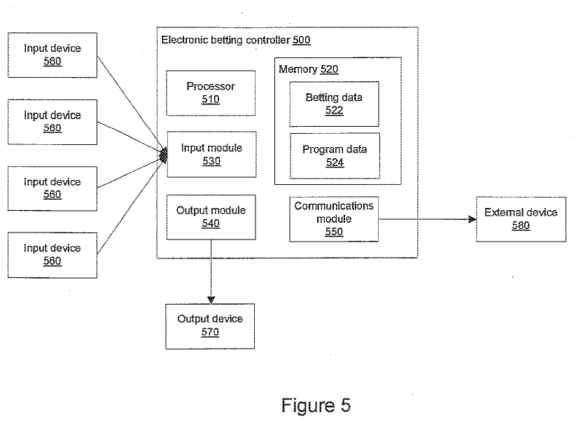

According to some embodiments, gaming apparatus 100 may include an electronic betting controller 500. FIG. 5 shows a block diagram of the components of electronic betting controller 500. Electronic betting controller 500 may include a processor 510, a memory 520, an input module 530, an output module 550, and a communications module 550.

Processor 510 may be a central processing unit, a microcontroller-based platform, a suitable integrated circuit, or one or more application-specific integrated circuits (ASIC's). Processor 510 may be in communication with or operable to access or to exchange signals with memory 520, input module 540, output module 550, and communications module 530.

Instructions and data to control operation of the Processor 510 may be stored in memory 520. Memory 520 may comprise both volatile and non-volatile memory and may comprise more than one of each type of memory. For example, the memory 520 may comprise RAM, ROM, and non-volatile memory in the form of a memory card, such as compact flash. RAM may include non-volatile RAM (NVRAM), magnetic RAM (MRAM), ferroelectric RAM (FeRAM), and other forms as commonly understood in the gaming industry. Memory 520 may comprise betting data 522 and program data 524. Program data 524 may store executable code, which when executed by the processor 510, allows for the receipt and processing of bets made using electronic betting apparatus 500.

Input module 530 communicates with input devices 560, which may be integrated into gaming apparatus 100 to be positioned proximate the players' positions. According to some embodiments, an input device 560 may also be positioned proximate the dealer. Input devices 560 may include pushbuttons and touch screen sensors, among other inputs. Received inputs are decoded by input module 530 and communicated to processor 510. Input devices 560 may be used to receive bet inputs from players in place of betting segments 150. According to some embodiments, one input device 560 may be provided for each desired betting segment 150, and each user may activate one or more input devices 560 to place their bets. According to some alternative embodiments, one input device 560 may be provided per player, allowing a player to select one or more virtual betting segments on each input device 560. According to some embodiments, input devices 560 may also be used to receive input from the dealer or game official.

Output module 540 may be configured to communicate with output devices 570, which may be integrated into gaming apparatus 100 to be positioned proximate a dealer position. Output device 570 may include one or more screens, speakers, lights, or other outputs. Output module 540 may communicate with output device 570, to cause output device 570 to display any placed bets to a dealer or game official.

Communications module 550 may allow electronic betting controller 500 to communicate with one or more external devices 580 through wireless or wired communication means. For example, communications module 550 may facilitate communication through USB, Bluetooth, Wi-Fi, Ethernet, or other communication protocols. External devices 580 may be computing devices, memory devices and/or servers, and may be used to monitor and store data relating to the use of gaming apparatus 100.

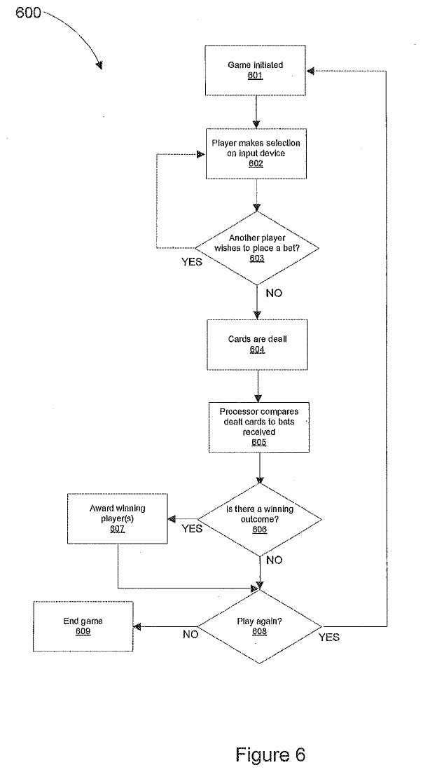

FIG. 6 shows a flowchart 600 showing a method of playing a game using gaming apparatus 100 with an integrated electronic betting controller 500 and plurality of playing cards 310. The method starts at step 601 when a game is initiated by a dealer through an input device 560, and a dealer or game official asks players to place their bets. At step 602, a player places a bet by selecting one or more options presented on an input device 560. The option the player elects may correspond to a property of a card that the player believes will be drawn by the dealer or game official. Inputs received by input devices 560 may be stored in betting data 522 of memory 520. At step 603, if another player wants to place a bet, the method moves back to step 602. Alternatively, the method moves through to step 604.

At step 604, the dealer or game official announces that no more bets will be taken, and then deals one or more cards from the plurality of cards 310 and place them on card dealing area 130 to form a dealer's hand or house hand 315 (as shown in FIG. 3). According to some embodiments, the cards may be electronically selected using a random number generator and virtually dealt on an output device 570 or other display device. According to some embodiments, the cards may be dealt using a dealer's shoe, or other device for holding or dealing cards, as described above with reference to FIG. 2.

Once the cards have been drawn and their values, suits, or other distinguishing features have been revealed, either physically or electronically, the method moves to step 605, at which time game outcomes are evaluated. The evaluation may be performed by processor 510 executing program data 524 to compare the characteristics of the cards drawn with the characteristics selected via input devices 560. If the characteristics of one or more drawn cards 310 of the dealer's hand 315 match a selected characteristic, a winning outcome is considered to have occurred. At step 606, if a winning outcome is determined, the method moves to step 607. Alternatively, the method moves to step 608.

At step 607, any winning players are awarded. The award may be in the form of betting tokens, wherein the monetary value of the betting tokens awarded is relative to the monetary value of the betting token used to place the bet, and/or the value corresponding to the betting segment 150.

At step 608, the one or more players may be given the opportunity to play again. If at least one player elects to play again, the method may return to step 601. Alternatively, the game may end at step 609.

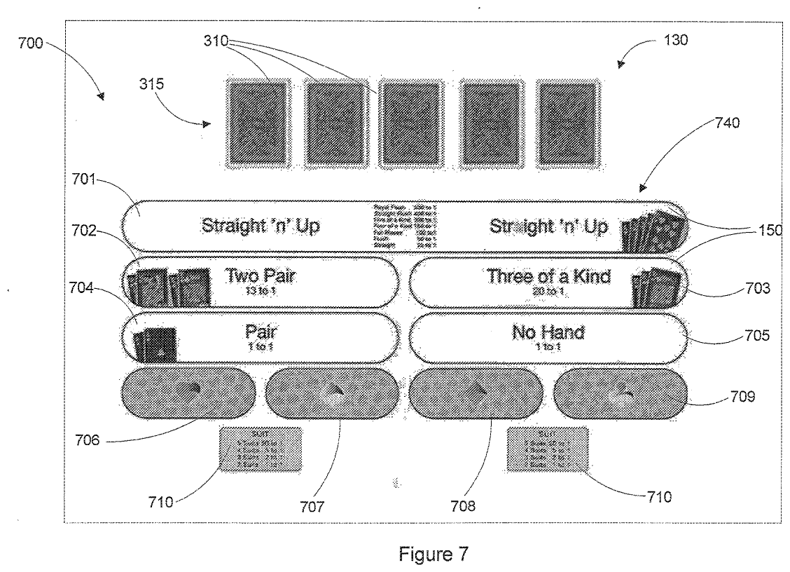

FIG. 7 shows an alternative playing surface 700 according to some embodiments, having a card dealing area 130 and a betting area 140 made up of nine betting segments 150. Betting segments 150 may be demarcated by lines or other graphic representations printed, painted, engraved, or otherwise fixed onto the gaming surface 800 in some embodiments. In the illustrated embodiment, five cards 310 have been dealt to card dealing area 130 to make up a dealer's hand 315. Betting segments 150 may include segments that relate to properties of the cards 310 making up the dealer's hand 315. According to some embodiments, the betting segments may correspond to typical hands used for the game of poker. For example, where one or more standard decks of cards is being used, betting segments 150 may correspond to one or more of:
a straight flush, being five cards in sequence, all of the same suit;
four of a kind, being four cards of one rank and any other unmatched card;
a full house, being three matching cards of one rank and two matching cards of another rank;
a flush, being five cards of the same suit, but not in sequence;
a straight, being five cards of sequential rank in at least two different suits;
three of a kind, being three cards of the same rank, plus two cards which are not of this rank nor the same as each other;
two pair, being two cards of the same rank, plus two cards of another rank that match each other but not the first pair, plus any card not of either rank; and
one pair, being two cards of one rank, plus three cards which are not of this rank nor the same as each other.

In the illustrated embodiment, betting segments 150 include a straight and above betting segment 701, a two pair betting segment 702, a three of a kind betting segment 703, a pair betting segment 704, a no hand betting segment 705, a hearts betting segment 706, a spades betting segment 707, a diamonds betting segment 708, and a clubs betting segment 709. Segments 701, 702, 703, 704, and 705 show the odds of the game outcome corresponding to the segment occurring in any given game. For example, segment 702 shows that an outcome of two pairs will result in winnings of 13 to 1 based on the player's bet amount. Segment 704 shows that the odds for getting a pair are 1 to 1, segment 703 shows that the odds for getting three of a kind are 20 to 1, and segment 705 shows that the odds for getting no hands are 1 to 1. Segment 701 shows the odds of each of the game outcomes that may result in a winning outcome, as described below.

Betting on one of the suit segments 706, 707, 708 or 709 may result in a winning outcome if two or more of the cards dealt to dealer's hand 315 are of the suit bet on. According to some embodiments, the amount won may depend on the number of cards dealt of the selected suit. For example, a result of 5 cards with the selected suit may payout with odds of 50 to 1, a result of 4 cards with the selected suit may payout with odds of 4 to 1, a result of 3 cards with the selected suit may payout with odds of 2 to 1, and a result of 2 cards with the selected suit may payout with odds of 1 to 1. These odds may be displayed in information boxes 710.

Betting on straight plus segment 701 may result in a winning outcome if the dealer's hand is a royal flush, straight flush, five of a kind, four of a kind, full house, flush, straight, or other predetermined card combination. According to some embodiments, a royal flush may payout with odds of 500 to 1, a straight flush may payout with odds of 400 to 1, a five of a kind may payout with odds of 300 to 1, a four of a kind may payout with odds of 100 to 1, a full house may payout with odds of 100 to 1, a flush may payout with odds of 50 to 1, and a straight may payout with odds of 25 to 1.

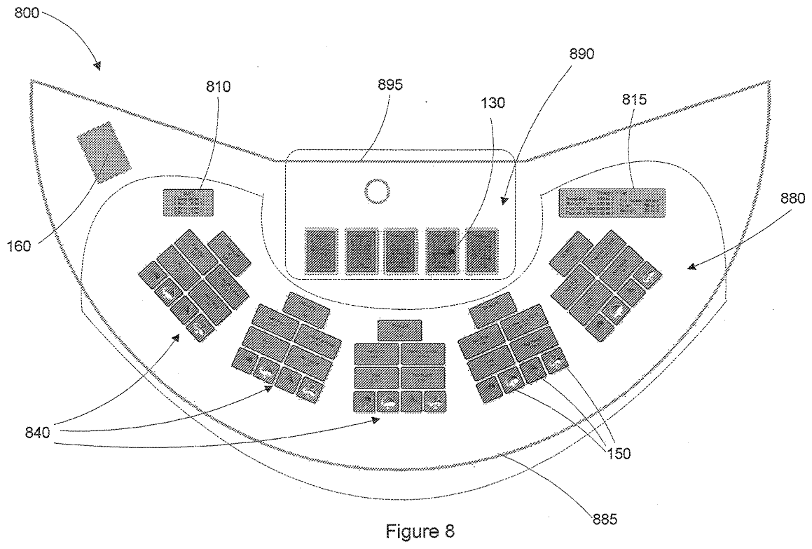

FIG. 8 shows a top view of an alternative gaming surface 800. Gaming surface 800 may include a players' area 880 and a dealer's area 890, designated by dotted lines. Players' area 890 may include one or more betting areas 840, and dealer's area 890 may include a card dealing area 130. Gaming surface 800 may be a felt-covered, partially felt-covered, fabric-covered, partially fabric-covered, or other gaming surface in some embodiments.

Gaming surface 800 may be generally D-shaped or semi-circular. Gaming surface 800 may have a player-facing edge 885 which may be one or more of curved, convex and semi-circular. Gaming surface may also have a dealer-facing edge 895 which may be substantially straight, or concave. According to some embodiments, dealer-facing edge 895 may comprise one or more straight edges, such as three straight edges forming a concave shape, as illustrated in FIG. 8. According to some embodiments, gaming surface 800 may be another shape, such as generally square, oval, or circular. According to some embodiments, players' area 880 may be situated adjacent player facing edge 885, and a dealer's area 890 may be situated adjacent the opposing dealer-facing edge 895. Player facing edge 885 may be the closest edge to players' areas 880, and dealer facing edge 895 may be the closest edge to dealer's area 890. A plurality of betting areas 840 may be positioned adjacent player-facing edge 885, and card dealing area 130 may be positioned adjacent the dealer facing edge 890, and central to dealer facing edge 890. According to some embodiments, gaming surface 800 may comprise 1, 2, 3, 4, 5, 6, 7, 8, 9, or more betting areas 840. According to some embodiments, each of betting areas 840 may be substantially identical. Gaming surface 800 may be sized so that a dealer standing proximate dealer's area 890 may be able to reach the opposite side of gaming surface 800 using a standard chip rake.

Each of betting areas 840 may be divided into two or more different betting segments 150 as described in further detail above with reference to FIG. 7. Betting segments 150 may be demarcated by lines or other graphic representations printed, painted, engraved, or otherwise fixed onto the gaming surface 800 in some embodiments. Each betting segment 150 may correspond with at least one game outcome or at least one property of at least one playing card, as described above. Furthermore, each betting segment 150 may be designated a value or probability, corresponding to the probability that the game outcome corresponding to the betting segment 150 is likely to occur. A textual or pictorial representation of the at least one game outcome or property that is associated with each betting segment 150 may be printed, painted, engraved, or otherwise marked onto gaming surface 800. According to some embodiments, textual or pictorial representation of the at least one game outcome or property that is associated with each betting segment 150 may be printed, painted, engraved, or otherwise marked in information boxes 810 and 815, located on gaming surface 800 in or near the players' area 880. Any textual or pictorial representations may be oriented to be readable from the players' area 880. According to some embodiments, card dealing area 130 may be at one side or end of gaming surface 800, while betting area 140 may be on the opposite side of gaming surface 800. Gaming surface 800 may be configured to allow a dealer or game official to easily access card dealing area 130, while allowing one or more players to easily access betting area 840.

Card dealing area 130 may include at least one shape printed, painted, engraved, or otherwise marked onto gaming surface 800, to designate where a dealer should place any dealt cards. In some embodiments, card dealing area 130 may include a single marked shape, which may be a rectangle in some embodiments, into which each dealt card is placed. According to some embodiments, card dealing area 130 may include a marked shape for each card to be dealt. The marked shapes may be sized and shaped to match the size and shape of the playing cards 310. According to some embodiments, card dealing area 130 may include pictorial depictions of the back side of the playing cards 310. Any textual or pictorial representations in card dealing area 130 may be oriented to be readable from the dealer's area 890.

During game play, a dealer or game official may stand proximate the dealer's area 890, while players may stand around the player-facing edge 885 of gaming surface 800, proximate players' area 880. Gaming surface 880 may further include a card shoe 160 for holding cards 310 to be dealt. According to some embodiments, card shoe 160 may be any mechanical or electronic card shoe configured to assist in dealing one or more cards from a plurality of cards, and may be positioned to the left hand side of card dealing area 130 from the point of view of a dealer standing proximate dealer's area 890.

According to some embodiments, the configuration illustrated in FIGS. 7 and 8 may provide some security advantages for gameplay. In particular, the betting segment 150 having the highest payout may be positioned closest to the dealer's area 890 or the dealer-facing edge 895. This may decrease the risk of past posting, or players deceptively trying to place bets on the betting segment after the dealer has stopped accepting bets or after the cards have already been dealt. In the illustrated embodiment, the betting segment 150 having the highest payout is straight and above betting segment 701.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A gaming table for playing a game of chance, the table comprising:
a table surface;
at least one betting area designated on the table surface; and
two or more segments in each betting area, each segment corresponding to a different property of a hand of cards and having a predetermined payout amount;
wherein the betting area corresponds to at least one property of at least one of the cards; and
wherein the segments are arranged on the gaming table so that the segment having the highest payout amount is positioned closest to a dealer's area of the table.

2. (canceled)

3. A method of playing a game of chance using at least one deck of cards and a gaming table, the gaming table comprising a table surface, at least one betting area designated on the table surface, the betting area corresponding to at least one property of a hand of cards, the method comprising the steps of:
receiving at least one token in at least one betting area;
a dealer dealing at least one card to form a house hand; and
determining a winning outcome for the player based on a relationship between at least one property of the house hand, and the player selected betting area.

4. The method of claim 3, wherein the at least one deck of cards is a standard deck of cards.

5. The method of claim 3 or claim 1, wherein the at least one property of a hand of cards corresponds to the characteristics of a standard poker hand.

6. The method of claim 3, further comprising determining a winning amount based on a relationship between at least one property of the house hand, and the player selected betting area.

7. (canceled)

8. The method of claim 3, wherein the betting area includes two or more segments, each corresponding to a different property of a hand of cards.

9. (canceled)

10. The method of claim 8, wherein the segments are arranged on the gaming table so that the segment having the highest payout amount is positioned closest to a dealer's area of the table.

11. The gaming table of claim 1, wherein the dealer's area comprises a card dealing area.

12. The gaming table of claim 1, wherein at least one segment corresponds to the drawn hand of cards being at least one of a set of predetermined standard poker hands.

13. The gaming table of claim 12, wherein the set of predetermined standard poker hands includes at least one of a royal flush, straight flush, five of a kind, four of a kind, full house, flush or straight.

14. The gaming table of claim 1, wherein at least one segment corresponds to the drawn hand of cards being of a predetermined card suit.

15. The gaming table of claim 14, wherein the predetermined card suit is at least one of hearts, spades, diamonds or clubs.

16. The gaming table of claim 1, wherein the table comprises two or more betting areas.

17. A method of playing a game of chance using a gaming table, the gaming table comprising a table surface, an electronic betting controller, and at least one betting area designated on the table surface, the betting area corresponding to at least one property of a hand of cards, the method comprising the steps of:
receiving from at least one player an electronic selection of a virtual betting area using an input device in communication with the electronic betting controller;
a dealer dealing at least one card to form a house hand; and
the electronic betting controller determining a winning outcome for the player based on a relationship between at least one property of the house hand, and the player selected betting area.

18. The method of claim 17, wherein the at least one deck of cards is a standard deck of cards.

19. The method of claim 17, wherein the at least one property of a hand of cards corresponds to the characteristics of a standard poker hand.

20. The method of claim 17, further comprising the electronic betting controller determining a winning amount based on a relationship between at least one property of the house hand, and the player selected betting area.

21. The method of claim 17, wherein the at least one card is dealt virtually.

22. A gaming table for playing a game of chance according to the method of claim 17, the table comprising:
a table surface; and
an electronic betting controller comprising:
a processor;
a memory storing code executable by the processor; and
at least one input device;
wherein the input device is configured to accept input corresponding to at least one property of at least one card of a deck of cards.

23. The gaming table of claim 22, further comprising an output device configured to display at least one received bet.
